(19) United States
(12) Patent Application Publication
(10) Pub. No.: US 2004/0119430 A1
(43) Pub. Date: Jun. 24, 2004

(54) Power fan speed controller

(76) Inventor: Vincent Lai, Taoyuan Hsien (TW)

Correspondence Address: Keith Kline, PRO-TECHTOR INTERNATIONAL SERVICES, 20775 Norada Court, Saratoga, CA, 95070-3018, US

(21) Appl. No.: 10/210,699

(22) Filed: Jul. 31, 2002

(51) Int. Cl. H02P 7/00; F04B 49/06

(52) U.S. Cl. 318/268; 417/44.11

(57) ABSTRACT

A power fan speed controller is capable of adjusting a fan speed synchronously along with the variation of a load power so as to solve the shortcomings of a conventional, unsteady, not precise enough and temperature-controlled fan speed controller. The structure of the present invention detects a power signal at the power source end and converts the power signal into a voltage signal in direct ratio to the power; the voltage signal is transmitted into a comparator to compare with a reference voltage thereby controlling a transistor connected with the fan.

### BACKGROUND OF THE INVENTION

1) Field of the Invention

The present invention relates to a power fan speed controller, more particularly to a controller capable of inducing a variation of a load power to change the revolving speed of the fan thereby solving the not precise enough and unsteady situation of a conventional temperature-induced fan speed controller.

2) Description of the Prior Art

Accordingly, the revolving speeds of most of the present fans are automatically controlled through temperature induction, that is the induction of temperature changes; when the temperature exceeds a determined degree, the revolving speed of the fan increases to strengthens the heat dissipation effect; however, when the temperature is low, the revolving speed of the fan reduces thereby achieving the advantages of decreasing the noise, saving the electricity and extending the useful life of the fan. All the power supplies of the present computers use heat-sensitive electric resistance or temperature-sensitive elements to detect the temperature degree to control the revolving speeds of the fans. For example, “An Automatically Adjusting Device for Reducing Fan Noise of a Computer” of Taiwan Patent number 199638 uses the heat-sensitive electric resistance to detect the temperature of a heat-generating element, such as a power transistor, on a circuit board. When a high temperature is detected, the resistance of the heat-sensitive electric resistance reduces and that increase the revolving speed of the fan. When the detected temperature drops, the resistance increases to slow or even stop the revolving speed of the fan. However, using the heat-sensitive electric resistance to control the revolving speed of the fan has the problems of being not stable and precise enough as well as having more error occurrences. As known, the heat-sensitive electric resistance is not a linear element, therefore, it is unable to fulfill the linear requirement; in addition, the heat-sensitive electric resistance is subjected to the influence from the external and environmental temperature thereby unable to specifically reflect the actual temperature status of a certain portion but easily causing the problem of unsteady detection. Furthermore, the contact point between the heat-sensitive electric resistance and the object to be detected tends to be crucially affected by the size of the contact area, the relative distance and the contact portion. Since the heat-sensitive resistance is subjected to the environmental and temperature interference as well as the contact point is hard to control and not linear, the conventional fan speed controller is unable to achieve a steadily and specifically controlling effect and therefore truly needs improvement.

### SUMMARY OF THE INVENTION

The primary objective of the present invention is to provide a power fan speed controller through directly capturing the power operation amount as a control reference; the increase of the power operation accelerates the revolving speed of the fan; the decrease of the power operation correspondingly reduces the revolving speed of the fan. This application is obviously more direct than the method of the conventional temperature induction. The present invention not only has the advantage of having more specific control but also solves the problems of being not linear and subjected to the interference of the environmental temperature derived from the conventional temperature induction. Therefore, the present invention of a fan speed controller meets the requirements of being steady and controlling precisely.

The secondary objective of the present invention is to provide a power fan speed controller capable of capturing a load current amount and conducting a conversion operation to obtain a voltage value in direct ratio to the load power; through the comparison and drive circuits, the voltage value controls the revolving speed of the fan.

To enable a further understanding of the structure, features and the other objectives of the present invention, the brief description of the drawings below is followed by the detailed description of the preferred embodiment.

### BRIEF DESCRIPTION OF THE DRAWINGS

FIG. 1 is a work curve diagram of the present invention.

FIG. 2 is a circuit diagram of the present invention.

### DETAILED DESCRIPTION OF THE PREFERRED EMBODIMENTS

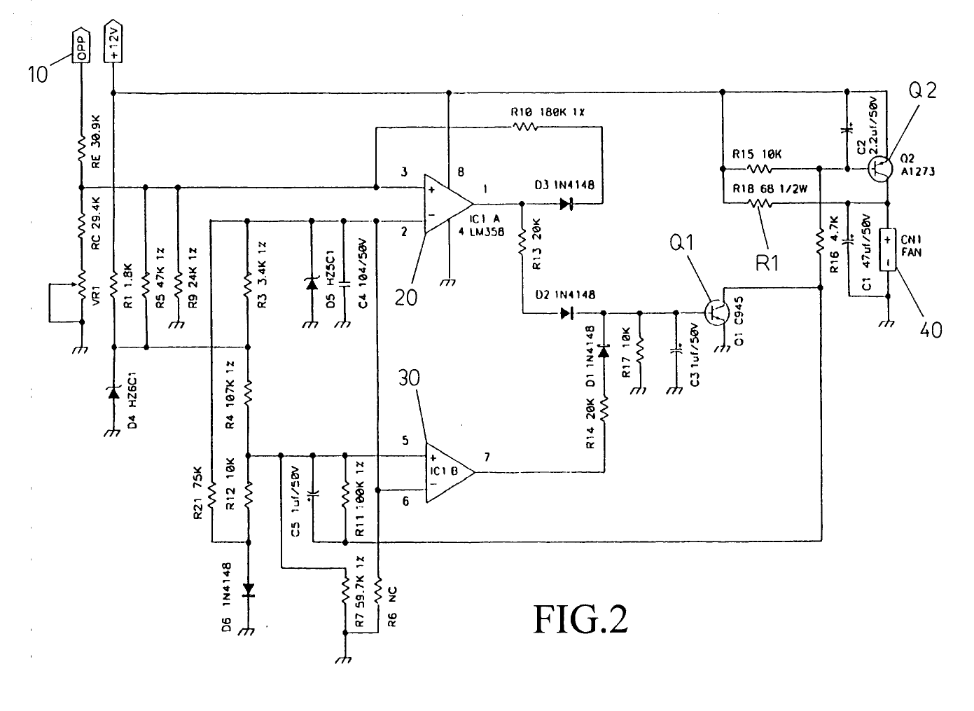

Referring to FIG. 2, the present invention of a power fan speed controller mainly comprises comparators (20, 30), transistors (Q1, Q2) and a voltage reduce electric resistance (R1), wherein an input end (10) is a terminal point for power detection and the front end thereof is capable of receiving a load power value which has to be pre-converted into a corresponding voltage variation signal; after the signal is input, it is transmitted into the comparator (20) to be compared with a reference voltage set by a reference voltage comparator (30). If the signal is higher than the reference voltage, the cascaded transistors (Q1, Q2) are communicated to make a connection point (40) of the fan on the right side of FIG. 2 to supply VCC to the fan for conducting a full speed operation. When the input induced voltage is lower than the reference voltage, the communication between the two transistors (Q1, Q2) is cut and the fan is limited by a voltage reduce electric resistance (R1) thereby only providing lower supply voltage to make the fan operate in a lower speed.

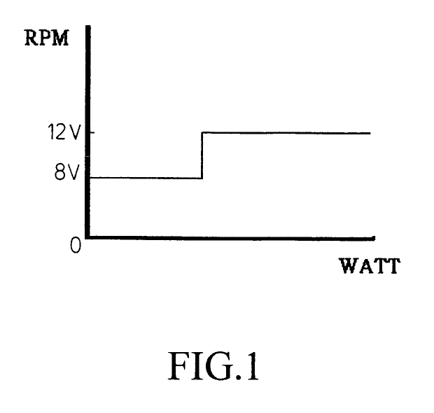

FIG. 1 shows the work curve of the fan voltage and the input wattage (the linear voltage); in the exemplary embodiment the fan revolving speed is set to have a high and a low speed variation. When the input wattage (the load power) is at a lower value, the fan voltage is about 8 watts and in a lower revolving operation. When the input wattage exceeds a certain reference value, it rapidly ascends to 12 watts of a rating voltage value such that the fan converts to a full speed operation pattern; the embodiment provides a design capable of changing the revolving speed of the fan according to the variation of the power. By virtue of the structure, the revolving speed of the fan is adjustable to have multiple levels or no level according to the variation of the load power and that is of the reasonable embodiment scope of the present invention.

As to the application scope, the present invention is capable of being integrated inside a power supply of a computer as a control circuit for the revolving speed of a built-in fan. In addition, the present invention is applied to the machine case fan, the central processor heat sink fan, the computer peripheral heat sink fan, etc; through the structure of detecting the load power to adjust the revolving speed of the fan, the present invention specifically solves the shortcomings of being not accurate, not steady and having serious errors of a conventional heat-sensitive resistance and temperature-sensitive element so as to provide a more direct power detecting status with lower damage and high steadiness.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A power fan speed controller comprises:
a power induction input end to obtain a voltage value from a power source output end or a load end and in direct ratio to an output or load power value;
a comparator to compare the voltage value transmitted from the power induction input end with a reference value for outputting a high or low controlling signal;
a transistor driven by a signal output from the comparator and disposed with the fan at an output end thereof,
the structure comprises a fan speed controller capable of changing the revolving speed of the fan according to the detected power variation.

2. A power fan speed controller according to claim 1, wherein the power induction input end receives a signal from a power converter which is capable of detecting load current value and converting it into a corresponding voltage signal.

3. A power fan speed controller according to claim 2, wherein the power converter comprises a current transformer connected with the power source output end or a load end.

4. A power fan speed controller according to claim 1, wherein, the voltage reference value is provided by another comparator.

5. A power fan speed controller according to claim 1, wherein the transistor comprises two cascaded transistors.

6. A power fan speed controller according to claim 1, wherein a voltage reduce resistance bridges over the connected point between the transistor and the fan to provide the supply source to the fan in low speed operation when the transistor is cut off.
